(19) United States
(12) Patent Application Publication
(10) Pub. No.: US 2017/0228779 A1
(43) Pub. Date: Aug. 10, 2017

(54) AUDIENCE IDENTIFICATION AND INTEREST DETERMINATION FROM TARGETED TOPICAL ACTIVITY SYSTEM AND METHOD

(71) Applicant: MarketChorus, Inc., Dallas, TX (US)

(72) Inventors: Matthew S. Sommer, Plano, TX (US); Stephen Edmonson, Richardson, TX (US)

(73) Assignee: MARKETCHORUS, INC., Dallas, TX (US)

(21) Appl. No.: 15/440,236

(22) Filed: Feb. 23, 2017

Related U.S. Application Data
(63) Continuation-in-part of application No. 15/004,031, filed on Jan. 22, 2016.
Application No. 15/004,031 is a continuation of application No. 14/186,192, filed on Feb. 21, 2014, now Pat. No. 9,276,974.
Application No. 14/186,192 is a continuation-in-part of application No. 13/648,588, filed on Oct. 10, 2012, now Pat. No. 8,930,384.
(60) Provisional application No. 61/546,211, filed on Oct. 12, 2011.

(51) Int. Cl. G06Q 30/02; G06Q 50/00; H04L 29/08

(52) U.S. Cl. CPC G06Q 30/0256; H04L 67/22; G06Q 50/01; G06Q 30/0277

(57) ABSTRACT

A system for building sets of user devices communicatively connected to a communications network, having a common or related topical interest in items available via communications over the network by the user devices with an item server. The user devices, respectively, have respective network identifiers and each exhibits related topical activity of particular articles in a subnetwork of the communications network, for example, in a social communications network. A server communicatively connected to the subnetwork detects communicative interactions over the subnetwork of the user devices with the particular articles. The system includes a collector communicatively connected to the communications network for obtaining a group of articles from the server, an identifier communicatively connected to the collector, the identifier determines the particular articles as a subset of the group of articles, a query device communicatively connected to the identifier and the communications network, the query device communicates over the communications network with the subnetwork obtaining the respective network identifiers of the user devices, respectively, interactive with the particular articles through communications over the communications network, a generator communicatively connected to the query device, the generator derives a tag corresponding to the particular articles, and a reporter is communicatively connected to the generator for delivering the respective network identifiers of the user devices, respectively, interactive with the particular articles and the tag. A topical collection of articles serves as a proxy to communications devices having particular interests for use in targeted advertising.

### CROSS-REFERENCE TO RELATED APPLICATIONS

The present application is a continuation in part and has benefit of priority of U.S. patent application Ser. No. 15/004,031 titled “Topical Activity Monitor System and Method,” filed on Jan. 22, 2016, which priority application is a continuation of and has benefit of priority of U.S. patent application Ser. No. 14/186,192 titled “Topical Activity Monitor System and Method,” filed Feb. 21, 2014 and issued on Mar. 1, 2016 as U.S. Pat. No. 9,276,974, which application is a continuation in part of and has benefit of priority of U.S. patent application Ser. No. 13/648,588, titled “Topical Activity Monitor System and Method,” filed Oct. 10, 2012 and issued on Jan. 6, 2015 as U.S. Pat. No. 8,930,384 (a conversion of U.S. Provisional Patent Application No. 61/546,211, filed Oct. 12, 2011). The priority application Ser. No. 15/004,031 is co-pending and has at least one same inventor of the present application.

### TECHNICAL FIELD

The invention generally relates to communications devices and communications network systems, and more particularly relates to set builders for devices exhibiting related topical activity in a computer network system.

### BACKGROUND

Articles, advertisements, software, files, apps, and other information and content items are often published (i.e., made accessible to others) on a computer network for access by users of computers communicatively connected to the network. User device access or interaction with a respective article or other item has typically not been monitored for purpose of gaining insight into user interest in applicable topical contents or subjects of the item. Measurements of popularity and attention to an idea, theme or other topic, however, may be desirable, as disclosed, for example, in U.S. Pat. No. 8,930,384 issued Jan. 6, 2015, and U.S. Pat. No. 9,276,974 issued Mar. 1, 2015.

It would be a significant improvement in the art to provide systems and methods for employing measurements of device activity with respect to item(s) to build sets of user devices of common topical interest activity in a communications network, as non-exclusive example, a social communications network of the Internet.

### SUMMARY

Embodiments of the invention include systems and methods for building sets of devices for use in targeting ads of topical interest or activity in or with respect to a search item, such as a word, text, image, or other.

An embodiment of the invention includes a system for building sets of user devices communicatively connected to a computer network system. The user devices, respectively, have respective network identifiers and each exhibits related topical activity of articles in a subnetwork of the computer network system as detected by an article server communicatively connected to the computer network system. The system includes a server device communicatively connected to the computer network system and storage communicatively connected to the server device. The storage includes instructions for controlling the server device in collecting articles available from the article server via communications by the server device with the article server over the computer network system, identifying a subset of the articles collected by the server device from the article server, querying the subnetwork for the respective network identifiers of the user devices corresponding to the subset of the articles, via communications over the computer network system by the server device with the subnetwork, generating tags corresponding to the subset of the articles and the user devices from querying, and reporting the user devices and the tags from generating.

Another embodiment of the invention is a system for building sets of user devices communicatively connected to a communications network. The user devices, respectively, have respective network identifiers and each exhibits related topical activity of particular articles in a subnetwork of the communications network detected by a server communicatively connected to the subnetwork. The server includes a group of articles, including the particular articles. The system includes a collector communicatively connected to the communications network for obtaining the group of articles from the server, an identifier communicatively connected to the collector, the identifier determines the particular articles as a subset of the group of articles, a query device communicatively connected to the identifier and the communications network, the query device communicates over the communications network with the subnetwork obtaining the respective network identifiers of the user devices, respectively, interactive with the particular articles through communications over the communications network, a generator communicatively connected to the query device, the generator derives a tag corresponding to the particular articles, and a reporter communicatively connected to the generator for delivering the respective network identifiers of the user devices, respectively, interactive with the particular articles and the tag.

Yet another embodiment of the invention is a method. The method includes collecting a group of articles by a server device communicatively connected to a communications network, from an article server communicatively connected to the communications network, identifying by the server device particular articles as a subset of the group of articles, querying by the server device over the communications network to a social network server of a social communications network subset of the communications network, for respective network identifiers of user devices, respectively, interactive with the particular articles through communications over the communications network, generating by the server device a tag, the tag corresponds to the particular articles, and reporting by the server device the respective network identifiers of the user devices, respectively, interactive with the particular articles and the tag.

Another embodiment of the invention is a system for ascertaining topics of items of interaction by user devices communicatively connected to a computer network system. The user devices, respectively, have respective network identifiers. The system includes a processing device communicatively connected to the computer network system and storage communicatively connected to the processing device. The storage includes instructions for controlling the processing device in receiving the respective network identifiers of the user devices, respectively, identifying by the processing device via communications over the computer network system a set of the user devices active with items available from an item server communicatively connected to the computer network system, analyzing the items of interaction by the user devices, respectively, for each of the user devices, respectively, and for all of the user devices, delivering topics of the items of interaction by the user devices, respectively, for each of the user devices, respectively, and for all of the user devices.

Yet another embodiment of the invention is a system for ascertaining topical items of interaction by user devices communicatively connected to a communications network. The user devices, respectively, have respective network identifiers on the communications network. The topical items correspond to at least one particular article accessible by the user devices, respectively, from a server communicatively connected to the communications network. The system includes a receiver for obtaining the respective network identifiers of the user devices, respectively, an iterator communicatively connected to the receiver, the iterator determines a subset of the user devices, respectively, interacting with the at least one particular article via communications of the user devices with the server over the communications network, an analyzer communicatively connected to the iterator, the analyzer derives at least one topical item of the at least one particular article, for each user device of the subset and for all of the user devices of the subset, and a reporter communicatively connected to the analyzer for delivering the at least one topical item and the respective network identifiers of the user devices of the subset corresponding to the at least one topical item, for each user device of the subset and for all of the user devices of the subset.

Another embodiment of the invention is a method. The method includes receiving by a processing device communicatively connected to a communications network, respective network identifiers of a group of user devices, respectively, communicatively connected to the communications network, iterating by the processing device a subset of the user devices, respectively, interacting with at least one particular article, by detecting from a social network server communicatively connected to the communications network the subset of the user devices interacting with the at least one particular article via communications of the user devices with the social network server over the communications network, analyzing by the processing device the at least one particular article and the subset of the user devices to obtain at least one topical item of the at least one particular article, for each user device of the subset and for all of the user devices of the subset, and reporting by the processing device the at least one topical item and the respective network identifiers of the user devices of the subset corresponding to the at least one topical item, for each user device of the subset and for all of the user devices of the subset.

### BRIEF DESCRIPTION OF THE DRAWINGS

The present invention is illustrated by way of example and not limitation in the accompanying figures, in which like references indicate similar elements, and in which:

FIG. 1 illustrates a system for building sets of user devices of topical activity in a communications network, according to certain embodiments of the invention;

FIG. 2 illustrates a method for building sets of user devices of topical activity in a communications network, according to certain embodiments of the invention;

FIG. 3 illustrates a system for ascertaining topics of items of interaction by user devices communicatively connected to a computer network system, according to certain embodiments of the invention; and

FIG. 4 illustrates a method of ascertaining topics of items of interaction by user devices communicatively connected to a computer network system, according to certain embodiments of the invention.

### DETAILED DESCRIPTION

According to certain embodiments, in a computer network system, articles (which include, but are not limited to, documents, advertisements, software, social media text, Uniform Resource Locator (URL) links, and other information content, and other items, each having or relating to one or more subject or topic) are available for access by computers communicatively connected to the network system. These articles are hosted or accessible on websites, servers, or other host devices of the network, for access by other devices communicatively connected to the network. The articles may be identified as having a particular topic or category. For example, an article that is a press release may relate to a particular company or event of that company; an article that is a social media post may relate to a particular company's stock or a consumer item (e.g., coffee, movie, etc.); an article that is software may be an application program (e.g., what is commonly known as an “app”) or other program or file representing an action processed by a microprocessor device to obtain a result; an article that is an advertisement may relate to any of a wide variety of consumer, business or other products or services offered; and numerous other examples of articles are possible. An article can also be a link to another article, such as a hyperlink or location or other link (e.g., a social media “like” or “share” of a web pointer to a content or other information or item). These various articles are “published” (e.g., broadly including, but not limited to, uploaded, stored, pushed, or otherwise provided or delivered or made accessible over the network) by a source device communicatively connected to the network, for access by other devices communicatively connected to the network through network communications between the source and other devices.

Each article references or represents one or more particular topical item. According to certain non-exclusive embodiments, device activity on a communications network with respect to articles is employed to identify sets of devices of related activity as proxy of interest of those devices in particular topical items of the articles. Those devices of related activity are then targeted for server device advertising and other services in the communications network. Further, other communications networks of similarly identifiable devices are also targeted. According to certain other non-exclusive embodiments, sets of devices of known identity are assessed in a communications network by a server device, to identify activities of the devices of the set with respect to articles. Topical items of the articles are analyzed, and the topical items are further segmented and analyzed for server device delivery of advertising and other services to devices via a communication network.

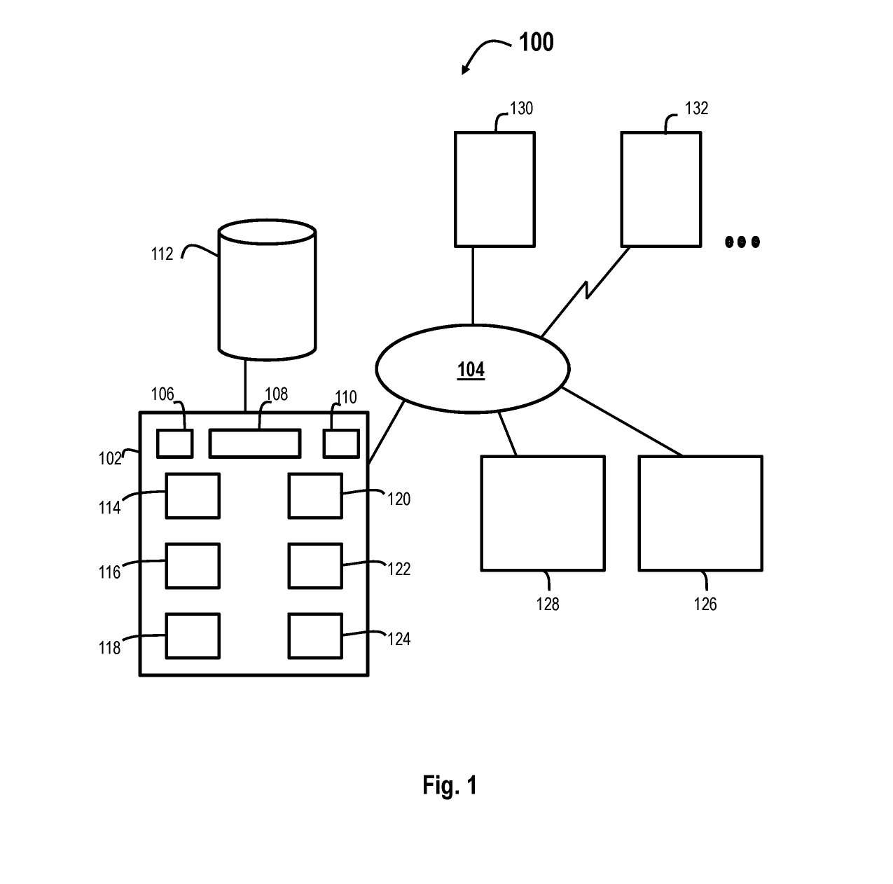

Referring to FIG. 1, a system 100 includes a server device 102 communicatively connected to a communications network 104. The server device 102 includes one or more processor 106 and memory 108. The server device 102 also includes one or more communication device, such as a modem, network card, or other network connector or device for communicating over the network 104. The server device 102 may, as non-exclusive example, be or include one or more server computer communicatively connected to the network 104 for processing software modules stored in memory, controlling interconnected hardware elements, and combinations of these, specially configured to provide operations and services later described.

The network 104 may, as non-exclusive example, be or include any one or more telecommunications network(s), any telecommunication and/or data network or combination of such networks, whether public, private or combinations of these, including, for example, the Internet, a local area network, wide area network, intranet, public switched telephone network (PSTN), wireless (e.g., cellular, WiFi, WLAN, GPS, infrared, satellite, radio frequency, or other) network, satellite network, other wired or wireless communication link or channel, combination of links or channels, or any combination of these. A non-exclusive example of the communications network 104 is the Internet, including but not limited to any and every possible combination of a wired data link, wireless cellular data link, and other link connected to the Internet (e.g., connected directly or indirectly connected through other links or networks).

A database 112 may be communicatively connected to, or included in whole or part in, the server device 102. The database 112 is, as non-exclusive example, a relational or other database, which may be or include software program stored in memory, hardware elements, or combination of these, or other tangible medium of storage. The database 112 is processed and controlled by the processor 106, in conjunction with the memory 108, and/or software modules stored in memory, interconnected hardware elements, and combinations of these, specially configured to provide operations and services later described.

The server device 102 includes, or communicatively connects, in whole or part to a collector 114. The collector 114 is or includes one or more software module stored in memory, interconnected hardware element, or combinations of these, specially configured to obtain one or more article on the network 104 from a device or devices (such as server computer or otherwise) communicatively connected to the network 104. A non-exclusive example of the collector 114 is a combination of a software program instructing the processor 106 to operate hardware elements, such as a network communication connector and database, to poll or otherwise detect or determine articles available from source devices, such as networked connected servers or other devices, communicatively connected to the network 104.

As used in this disclosure, the term “article” comprises a digital artifact of the network 104 or of a device or element of or communicatively connected to the network 104, which is usually processable or producible (e.g., displayed, edited, output) by a device communicatively connected to the network 104, and includes but is not limited to any of file, document, advertisement, software program, app, picture, graphic, object, or content item capable of being digitally represented in a storage, computer, or communicated signal of or communicatively connected to the network 104 or available for access by computers or devices connected to the network 104. Certain nonexclusive examples of such an article include a press release related to a particular company, or event, product or service of the company; a publication that is a company website or social media website post related to a particular company's stock or a consumer item (e.g., coffee, movie, or another product or service); a software program, script, code or other program or file available from or interactive with a website or computer connected to the network 104, representing an action processable by a microprocessor device to obtain a result (e.g., including, without limitation, what is commonly known as an “app”); advertisement for any of a wide variety of consumer, business or other products or services offered or other notice or announcement, available from the network 104 as pop-up, push, download or in any other manner; and numerous other examples of articles obtainable via communicative connection to the network 104 are possible (e.g., flash programs, cookies, website statistics, and others). Additionally, in other nonexclusive examples, an article can be or include a link to another distinct or related article, such as a hyperlink, identifier, or locator, or a location or other link or referral source (e.g., a social media “like” or “share” of a web pointer to a content, information or other item). These various articles are “published” (e.g., broadly including, but not limited to, uploaded, stored, pushed, or otherwise provided or delivered or made accessible via communications over the network 104) by one or more source device communicatively connected to the network 102, for access by another device communicatively connected to the network 104.

The collector 114 is communicatively connected to an identifier 116 in whole or part included in and/or communicatively connected to the server device 102. The identifier 116 is or includes one or more software module stored in memory, interconnected hardware element, or combinations of these, specially configured to identify a subset of articles obtained by the collector 114 from an input query, such as an article, word, phrase, URL, content, graphic or other object or item. A non-exclusive example of the identifier 116 is a combination of a software program instructing the processor 106 to determine a keyword or other query item, for example, via conceptual, vector space, probabilistic, clustering algorithm or other determination, or a set of related terms or phrases, from and/or through analysis of the articles obtained by the collector 114. In certain non-exclusive embodiments, the identifier is, for example, responsive to a query operation of a website for receiving the input query from a network-connected user or other device. In other alternatives, the identifier is responsive to a query provided by a feed, such as a news, RSS feed, Twitter, Facebook or other feed source. The identifier 116 yields a subset of the articles having relatedness corresponding to the determined keyword, query item, or set of terms or phrases, as applicable.

A query device 118 is communicatively connected to the identifier 116. The query device 118 may, in whole or part, be included in and/or communicatively connected to the server device 102. The query device 118 is or includes one or more software module stored in memory, interconnected hardware element, or combinations of these, specially configured to detect from a network, for example, the network 104, another communications network, or a subset thereof, such as a social communications network, identities of any devices sharing or otherwise acting in respect of the subset of the articles from the identifier 116. A non-exclusive example of the query device 118 is a combination of a software program instructing the processor 106 to request and receive from the network, for example, the network 104, a subset thereof (such as a social communications network), or as otherwise may apply, the addresses and/or handles corresponding to devices acting in respect of the subset of articles.

A generator 120 is communicatively connected to the query device 118. The generator 120 may, in whole or part, be included in and/or communicatively connected to the server device 102. The generator 120 is or includes one or more software module stored in memory, interconnected hardware element, or combinations of these, specially configured to extract or derive tags corresponding to the devices, as non-exclusive example, devices of or communicatively connected to a social communications network, acting in respect of the subset of articles of the query device 118. A non-exclusive example of the generator 120 is a combination of a software program instructing the processor 106 to extract or derive, such as by entity extraction, topic modeling (e.g., cluster labels), or other process, key terms, phrases or entities corresponding to the devices acting in respect of the subset of articles and the subset of articles.

The generator 120 is communicatively connected to a set builder 122 for devices acting in respect of the subset of articles. The set builder 122 may, in whole or part, be included in and/or communicatively connected to the server device 102. The set builder 122 is or includes one or more software module stored in memory, interconnected hardware element, or combinations of these, specially configured to create a set of those devices acting in respect of the subset of articles for targeting of ads. A non-exclusive example of the set builder 122 is a combination of a software program instructing the processor 106 to assess the devices and device activities for propriety of ads for targeting to the devices.

An updater 124 is communicatively connected to the generator 120. The updater 124 may, in whole or part, be included in and/or communicatively connected to the server device 102. The updater 124 is or includes one or more software module stored in memory, interconnected hardware element, or combinations of these, specially configured to trigger the collector 114 to update the articles obtained by the collector 114. A non-exclusive example of the updater 124 is a combination of a software program instructing the processor 106 to increment or otherwise initiate anew the collector 114 to commence or continue obtaining the articles.

The network 104 may include or communicatively connect to one or more article server 126 and one or more social communications network server 128. The network 104 may also include or communicatively connect to one or more user communication device 130, 132. Each article server 126 includes one or more server computer having or communicatively connected to any number and combination of processor, memory, storage and communications device. The article server 126 may source or otherwise directly or indirectly permit access to one or more article available to the server device 102 and respective devices 130, 132 via communications over the network 104. Each social communications network server 128 includes or communicatively connects to any number and combination of processor, memory, storage and communications device. The social communications network server 128 provides interface elements for communicating over the network 104 with the server device 102 to provide identities of any of the respective devices 130, 132 interacting with items corresponding to articles, respectively, available from the one or more article server 126, respectively. Each user communication device 130, 132 includes any number and combination of processor, memory, and communications device for interacting with articles, respectively, available from the one or more article server 126, respectively, via communications over the network 104 or any social communications network as subset thereof.

In operation, the server device 102 collects articles or network indicia or addresses of articles from article servers 126, which may be one or more, on the network 104. Of the collected articles, the server device 102 identifies one or more articles which are an articles subset of all of the articles collected. As non-exclusive example, the articles of the articles subset are identified by relation to a key word, phrase, or other identifier of the articles of the subset.

On identifying the articles subset, the server device 102, such as via input of an article, word, term, phrase, URL, content, graphic or other object or item, queries one or more social communications network server 128 or other communications device(s) of the network 104. From the query, the server device 102 determines respective identifiers for respective device(s) 130, 132, as applicable, interacting in relevant manner with the articles of the article subset. The server device 102 then generates tags for articles of the article subset. The tags may be, for non-exclusive example, key terms, phrases, entities from entity extraction, topic modeling (cluster labels), and URLs for the articles of the article subset. In certain non-exclusive embodiments, a website receives a query from a communicatively connected device and the server device 102 returns a collection of network identifiers for respective device(s) 130, 132 interacting with the article subset relevant to the query. In other alternatives, a query is supplied by a feed from a device, such as a news, RSS feed, Twitter, Facebook other feed source.

With the article subset and the identifiers for respective device(s) 130, 132, the server device 102 creates a set of network identifiers for the device(s) 130, 132. Using the network identifiers, the server device 102, or another device (not shown in detail) communicatively connected to the server device 102, as applicable, targets ads to the device(s) 130, 132 corresponding to the tags and device identifiers. Ads can be targeted, for example, using keywords, interests, behaviors, topics, emails/personal identifiers, network identifiers or other identifiers. The server device 102 then updates the articles collected by the server device 102.

In certain non-exclusive alternatives, the tags generated by the server device 102 may be employed by the server device 102 for accessing other networks, such as a social communications network, any subset of the network 104, or other network, to collect further articles. Additionally, in certain non-exclusive alternatives, the server device 102, or another device (not shown in detail) communicatively connected to the server device 102, as applicable, targets ads to device(s), which may or may not include devices 130, 132, as applicable, or the other networks.

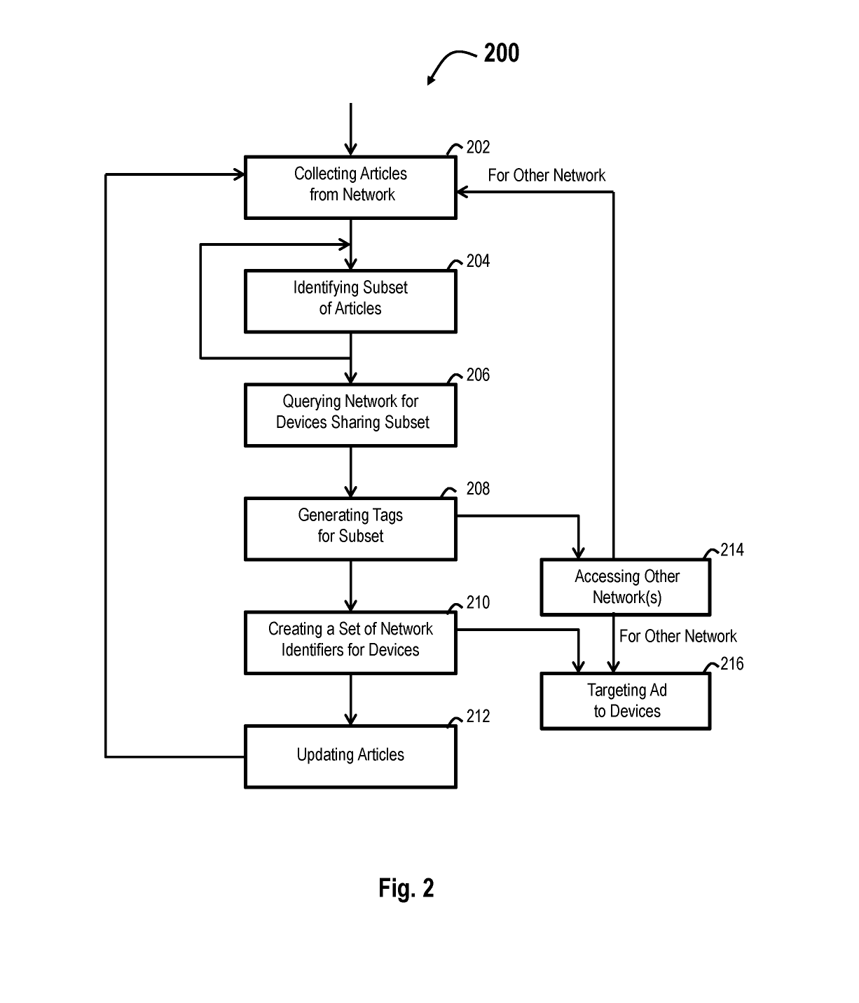

Referring to FIG. 2, a method 200 of a system, for non-exclusive example, the system 100 of FIG. 1 or otherwise, builds sets of devices of particular topical activity. The sets may be employed for targeting of ads and other actions. The method 200 commences with a step 202 of collecting articles accessible over a communications network from server or other devices communicating over the communications network. The collected articles are then analyzed to identify a subset of the articles in a step 204. The identification of the step 204 may be based on a keyword or other query, such as conceptual, vector space, probabilistic, clustering algorithm or other, and/or based on a set of related terms and phrases from analysis of any existing subset of articles or otherwise. As non-exclusive example, the subset of articles may be identified corresponding to an input query, such as an article, word, phrase, URL, content, graphic or other object or item, received to a website, from a news, RSS feed, Twitter, Facebook or feed source, or other application device. The input query is proxy of the particular topic of activity of communicatively connected user devices.

On identification in the step 204, the method 200 continues with a step 206 of querying over the communications network, or another network, to detect identifiers for user devices active in respect of the articles of the subset. For example, user devices that share, like or otherwise interact (or not) with the articles of the subset, are detected from relevant network(s), such as, for non-exclusive example, one or more social communications network, like Facebook™, Twitter™, or otherwise. In a step 208, tags are generated from the subset of articles identified in the step 204 and the set of user devices detected in the step 206. The tags, as non-exclusive example, may be key terms, phrases or entities from entity extraction, topic modeling (cluster labels), and otherwise, and the URLs for the subset of articles or the URLs as a whitelist or targeting list for display advertising.

In the method 200, a custom set of user devices for targeting is created in a step 208. In the step 208, the tags and set of user devices are assessed to yield the custom set of user devices. The method 200, in a step 212, updates the articles collected in the step 202 and continues.

In certain non-exclusive alternatives, the tags generated in the step 208 may be employed to access one or more other communications network(s) in a step 214. Those other communications network(s) may be, as non-exclusive example, one or more social communications network(s) or others, which may be a same, subset, different or other network, as applicable, of or from the network for collection of articles. Further in certain non-exclusive alternatives, the set of network identifiers for devices of the step 210 and the tags of the step 208 are employed in a step 216 for targeting ads to user devices.

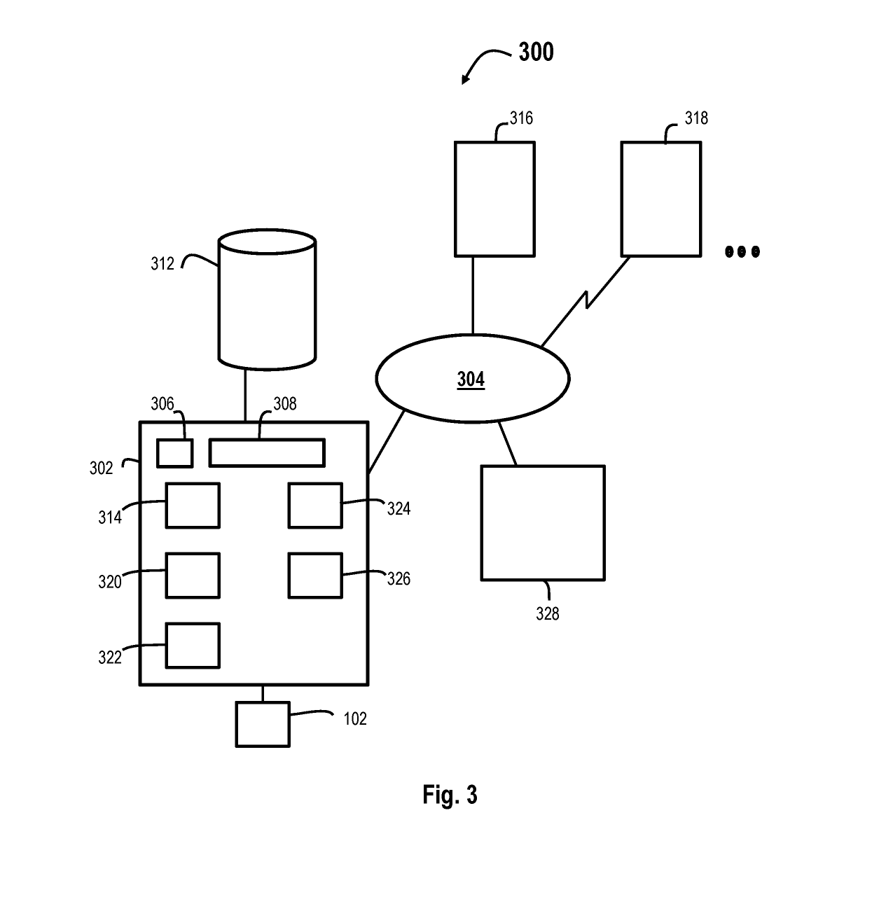

Referring to FIG. 3, another system 300 includes a processing device 302. The processing device 302 is communicatively connected to a communications network 304. The processing device 302 includes one or more processor 306 and memory 308. The processing device 302 also includes one or more communication device, such as a modem, network card, or other network connector or device for communicating over the network 304. The processing device 302 may, as non-exclusive example, be or include one or more computer communicatively connected to the network 304 for processing software modules stored in memory, controlling interconnected hardware elements, and combinations of these, specially configured to provide operations and services later described.

The network 304 may, as non-exclusive example, be or include any one or more telecommunications and/or data network(s), or combination of such networks, whether public, private or combinations of these, including, for example, the Internet, a local area network, wide area network, intranet, public switched telephone network (PSTN), wireless (e.g., cellular, WiFi, WLAN, GPS, infrared, satellite, radio frequency, or other) network, satellite network, other wired or wireless communication link or channel, combination of links or channels, or any combination of these. A non-exclusive example of the communications network 304 is or includes the Internet, including but not limited to any and every possible combination of a wired data link, wireless cellular data link, and other link connected to the Internet (e.g., connected directly or indirectly connected through other links or networks).

A database 312 may be communicatively connected to, or included in whole or part in, the processing device 302. The database 312 is, as non-exclusive example, a relational or other database, which may be or include software program stored in memory, hardware elements, or combination of these, or other tangible medium of storage. The database 312 is processed and controlled by the processor 306, in conjunction with the memory 308, and/or software modules stored in memory, interconnected hardware elements, and combinations of these, specially configured to provide operations and services later described.

The processing device 302 includes, or communicatively connects, in whole or part to a receiver 314. The receiver 314 obtains sets of email addresses, social network handles, or other identifiers of one or more user device(s) 316, 318 communicatively connected to the network 304. The sets may be compiled through automation, manually, or otherwise. As non-exclusive example, the email addresses, social network handles or other identifiers of the sets may be known identifiers of a company, competitor, known similar account, or otherwise.

An iterator 320 is communicatively connected to the receiver 314. The iterator 320 may, in whole or part, be included in and/or communicatively connected to the processing device 302. The iterator 320 is or includes one or more software module stored in memory, interconnected hardware element, or combinations of these, specially configured to detect from a network, for example, the network 304, another communications network, or a subset thereof, such as a social communications network, identities of any devices, as non-exclusive example, any of the user devices 316, 318, sharing, or, as applicable, otherwise acting, in respect of any particular article or articles available on the network 304 for access or interaction by the devices. A non-exclusive example of the iterator 320 is a combination of a software program instructing the processor 106 to request and receive from the network, for example, the network 104, a subset thereof (such as a social communications network), or as otherwise may apply, identifiers, such as, for example, the addresses and/or handles, corresponding to devices acting in respect of the article or articles.

An analyzer 322 is communicatively connected to the iterator 320. The analyzer 322 may, in whole or part, be included in and/or communicatively connected to the processing device 302. The analyzer 322 is or includes one or more software module stored in memory, interconnected hardware element, or combinations of these, specially configured to extract or derive topical items corresponding to articles that have been shared or otherwise acted upon by the user devices from the iterator 320. The analyzer 322 determines the topical items on a per user device basis. The analyzer 322 also determines the topical items that are important or commonly acted upon by all of the user devices from the iterator 320. A non-exclusive example of the analyzer 322 is a combination of a software program instructing the processor 306 to extract or derive, such as by entity extraction, topic modeling (e.g., cluster labels), or other process, key terms, phrases or entities corresponding to the article or articles shared or otherwise acted on by the user devices from the iterator 320.

The analyzer 322 is communicatively connected to a reporter 324. The reporter 324 may, in whole or part, be included in and/or communicatively connected to the processing device 302. The reporter 324 is or includes one or more software module stored in memory, interconnected hardware element, or combinations of these, specially configured to deliver the topical items determined on a per user device basis and overall for the user devices, to third party devices or entities. The topical items may be employed by the third party devices or entities, as non-exclusive example, as or for segmentation data for audience analysis, such as to add information about the user devices, and consequently the users of those devices, for marketing, advertising, or other purpose. A non-exclusive example of the reporter 324 is a combination of a software program instructing the processor 306 to deliver over the communication network 304 to another device connected to the network 304, a list or other report of topical items corresponding to the user devices.

A proxy device 326 is communicatively connected to the reporter 324. The proxy device 326 may, in whole or part, be included in and/or communicatively connected to the processing device 302. The proxy device 326 is or includes one or more software module stored in memory, interconnected hardware element, or combinations of these, specially configured to determine other user devices (other than those from the iterator 320) communicatively connected to a network, for non-exclusive example, the network 304, a subset thereof (such as a social communications network) or another network(s), and having correspondence to the topical items from the reporter 324. The proxy device 326, for example, may be communicatively connected to the server device 102 of certain of the embodiments of FIG. 1, for collecting articles corresponding to the topical items from the reporter 324. Those articles may then be employed, such as in the system 100 of FIG. 1 and the method 200 of FIG. 2, to determine sets of user devices, for example, for targeting ads or otherwise. A non-exclusive example of the proxy device 326 is a combination of a software program instructing the processor 306 to determine, such as via communications over one or more network, such as the network 304, a subset or social communications network thereof, with a social communications network server 328, or other network-connected device, any user devices, for example, the devices 316, 318, sharing or otherwise interacting with the articles. In certain non-exclusive embodiments, the proxy device 326 responds to an input query, such as an article, word, phrase, URL, content, graphic or other object or item, received to a website, from a news, RSS, Twitter, Facebook or other feed source, or other application device of or operated by the processing device 302. The input query corresponds to particular topic(s) of activity of communicatively connected user devices.

In certain non-exclusive alternatives, a segmenter is communicatively connected to the reporter 322. The segmenter obtains the list or other report of topical items corresponding to the user devices, and performs further analyses of the topical items and user devices for targeted advertising, email, or other uses. In certain other non-exclusive alternatives, the processing device 302, in whole or part, includes or communicatively connects to the server device 102 of FIG. 1. In such alternatives, the topical items and the user devices determined by analyzer 322 and the iterator 320, respectively, are employed to determine further articles and user devices acting in respect of those further articles.

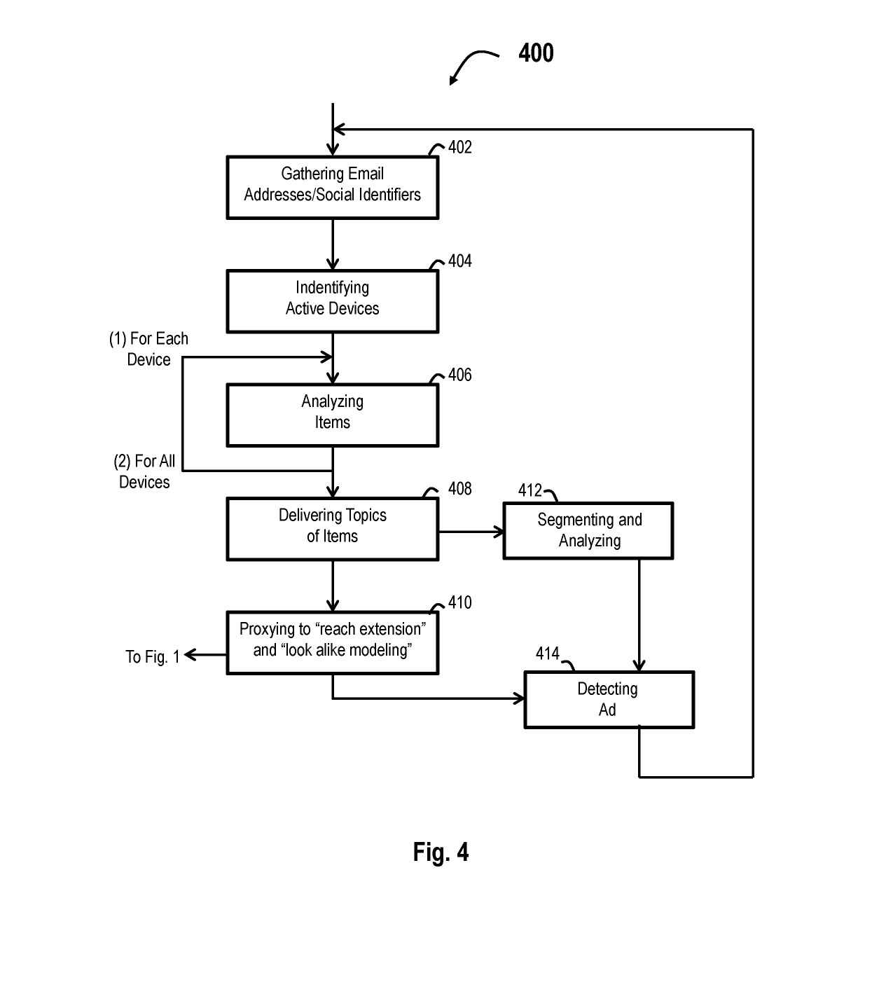

Referring to FIG. 4, a method 400 of a system, for non-exclusive example, the system 300 of FIG. 3 or otherwise, builds sets of devices of particular topical activity. The sets may be employed for targeting of ads and other actions. The method 400 commences with a step 402 of gathering email addresses, social network handles, or other identifiers of a given set of user devices. The step 402 may be automated via a server computer over a communications network, manually input to a computer, or combination, and may obtain identifiers, such as, for example, the addresses, handles, or other.

In a step 404, those of the user devices interactive (or not, as applicable) with one or more particular articles, such as, for non-exclusive example, those devices sharing or liking the one or more articles, are identified by address, handle or other identifier. The step 404 may be automated via a server computer over a communications network. The server computer communicates over the network with one or more other server, processor or device, such as, for non-exclusive example, a social communications network server computer. The server, processor or device may have an interface for communications over the network by the server computer.

An analyzing step 406 extracts or derives topical items corresponding to the one or more articles and those user devices selectively interacting with those articles. The step 406 determines the topical items on a per user device basis for those user devices identified in the step 404. The step 406 also determines the topical items that are important or commonly acted upon by all of these user devices. The step 406 may be automated via a server computer over a communications network to extract or derive, such as by entity extraction, topic modeling (e.g., cluster labels), or other process, key terms, phrases or entities corresponding to the articles. The server computer may, in the step 406, communicate over the network with one or more other server, processor or device, such as, for non-exclusive example, a social communications network server computer, which may have an interface for such communications.

In a step 408, the topical items from the step 406 are delivered, such as via a report or reporting, such as by a server device that performs the analyses of the step 406 or, if applicable, another processing device communicatively connected to the server device. In certain non-exclusive embodiments, the step 408 may be responsive to receipt of an input query, such as an article, word, phrase, URL, content, graphic or other object or item, by a website, a news, RSS, Facebook, Twitter or other feed source, or other application device of or communicatively connected to the server device. The input query corresponds to a particular topic(s) of activity of communicatively connected user devices. In the step 408, the topical items are reported for further action by a step 410 of proxying. The proxying step 410 may be performed by a processing device to determine other user devices (which, as applicable, may be same or different from of the steps 402, 406, 408) from the topical items reported from the step 408. As non-exclusive example, the processing device may communicate over a network with one or more server, processor or device, such as, for non-exclusive example, a social communications network server computer, which may have an interface for such communications, to obtain identifiers of the other user devices.

In certain non-exclusive alternatives, the proxying step 410 may call or initiate a set building method, such as the method 200 of FIG. 2. In this manner, the proxying step 410 invokes the method to reach extension and look-alike model for broader audience of user devices among a common or other topical item. In certain other non-exclusive alternatives, the delivering step 408 may report the topical items for segmenting and/or other analyses in a step 412. The segmenting and/or other analyses of the step 412 may be performed by one or more processing device for focused content marketing, content curation, content generation, advertising insights, web page customization, social advertising, display advertising, campaign creation or otherwise, any of which may, but need not necessarily, be automated by computers and communications over a network. Further certain non-exclusive alternatives include a step 414 of delivering ads to a group of user devices from the steps 410 and/or from the step 408. The step 414 may be performed automatedly by one or more processing device communicatively connected to a network connected to the group of user devices. The network may be, for non-exclusive example, the Internet or any subnetwork thereof, such as one or more social communications network. Alternately, the step 414 may be performed manually through conventional or Internet advertising to the group of user devices and/or users of those user devices.

The embodiments provide a wide variety of applications including for example, the embodiments and results thereof can be used as an indication of trending topics, to determine advertising, to determine most valuable web content for purposes of publication or distribution, as an indicator to help create original content with higher potential, as an indicator into topics for investment purposes, as a way to monitor online awareness around a brand, product, good or service, marketing message, and numerous other possibilities, variations, alternatives, additions and arrangements.

In the foregoing, the invention has been described with reference to specific embodiments. One of ordinary skill in the art will appreciate, however, that various modifications, substitutions, deletions, and additions can be made without departing from the scope of the invention. Accordingly, the specification and figures are to be regarded in an illustrative rather than a restrictive sense, and all such modifications substitutions, deletions, and additions are intended to be included within the scope of the invention. Any benefits, advantages, or solutions to problems that may have been described above with regard to specific embodiments, as well as device(s), connection(s), step(s) and element(s) that may cause any benefit, advantage, or solution to occur or become more pronounced, are not to be construed as a critical, required, or essential feature or element.

What is claimed is:

1. A system for building sets of user devices communicatively connected to a computer network system, the user devices, respectively, having respective network identifiers and each exhibiting related topical activity of articles in a subnetwork of the computer network system detected by an article server communicatively connected to the computer network system, comprising:
a server device communicatively connected to the computer network system;
storage communicatively connected to the server device, the storage includes instructions for controlling the server device in:
collecting articles available from the article server via communications by the server device with the article server over the computer network system;
identifying a subset of the articles collected by the server device from the article server;
querying the subnetwork for the respective network identifiers of the user devices corresponding to the subset of the articles, via communications over the computer network system by the server device with the subnetwork;
generating tags corresponding to the subset of the articles and the user devices from querying; and
reporting the user devices and the tags from generating.

2. The system of claim 1, wherein the instructions further include:
delivering a targeted message to the user devices corresponding to the tags.

3. The system of claim 1, wherein the instructions further include:
repeating the collecting based on the user devices corresponding to the tags to obtain another subset of the articles.

4. A system for building sets of user devices communicatively connected to a communications network, the user devices, respectively, having respective network identifiers and each exhibiting related topical activity of particular articles in a subnetwork of the communications network detected by a server communicatively connected to the subnetwork, the server includes a group of articles, including the particular articles, comprising:
a collector communicatively connected to the communications network for obtaining the group of articles from the server;
an identifier communicatively connected to the collector, the identifier determines the particular articles as a subset of the group of articles;
a query device communicatively connected to the identifier and the communications network, the query device communicates over the communications network with the subnetwork obtaining the respective network identifiers of the user devices, respectively, interactive with the particular articles through communications over the communications network;
a generator communicatively connected to the query device, the generator derives a tag corresponding to the particular articles; and
a reporter communicatively connected to the generator for delivering the respective network identifiers of the user devices, respectively, interactive with the particular articles and the tag.

5. The system of claim 4, further comprising:
an updater communicatively connected to the reporter and the collector, the updater invokes the collector to obtain another group of articles from the server.

6. The system of claim 4, wherein the communications network includes a social communications network having a social network server, further comprising:
a communications device communicatively connected to the reporter and the communications network, the communications device communicatively accesses the social network server to obtain other respective network identifiers of user devices, respectively, relative to the tag.

7. The system of claim 6, further comprising:
a digital advertiser communicatively connected to the reporter and the communications network, the digital advertiser sends a message for delivery to the respective network identifiers of the user devices, respectively, interactive with the particular articles and the tag.

8. A method, comprising:
collecting a group of articles by a server device communicatively connected to a communications network, from an article server communicatively connected to the communications network;
identifying by the server device particular articles as a subset of the group of articles;
querying by the server device over the communications network to a social network server of a social communications network subset of the communications network, for respective network identifiers of user devices, respectively, interactive with the particular articles through communications over the communications network;
generating by the server device a tag, the tag corresponds to the particular articles; and
reporting by the server device the respective network identifiers of the user devices, respectively, interactive with the particular articles and the tag.

9. The method of claim 8, further comprising:
updating the group of articles by the server device communicating over the communications network with the article server.

10. The method of claim 8, further comprising:
communicating by the server device communicatively connected to a social network server of a social communications network, to obtain other respective network identifiers of other user devices, respectively, interactive with the particular articles and the tag.

11. The method of claim 10, further comprising:
digitally advertising by the server device via communications over the communications network to the respective network identifiers of the user devices, respectively, interactive with the particular articles and the tag.

12. A system for ascertaining topics of items of interaction by user devices communicatively connected to a computer network system, the user devices, respectively, having respective network identifiers, comprising:
a processing device communicatively connected to the computer network system;
storage communicatively connected to the processing device, the storage includes instructions for controlling the processing device in:
receiving the respective network identifiers of the user devices, respectively;
identifying by the processing device via communications over the computer network system a set of the user devices active with items available from an item server communicatively connected to the computer network system;
analyzing the items of interaction by the user devices, respectively, for each of the user devices, respectively, and for all of the user devices;
delivering topics of the items of interaction by the user devices, respectively, for each of the user devices, respectively, and for all of the user devices.

13. The system of claim 12, wherein the instructions further include:
segmenting the user devices, respectively, for each of the user devices, respectively, and for all of the user devices, to yield respective network identifiers for the user devices, respectively, for delivery by the processing device of an advertisement over the communications to the user devices, respectively, at the respective network identifiers.

14. The system of claim 12, wherein the instructions further include:
determining other user devices via communications of the processing device over the computer network system to the other user devices, for the topics as proxy.

15. The system of claim 13, wherein the instructions further include:
providing a digital ad via the computer network system by the processing device to the user devices, respectively, from segmenting, at the respective network identifiers for the user devices, respectively, from segmenting.

16. The system of claim 14, wherein the instructions further include:
providing a digital ad via the computer network system by the processing device to the other user devices.

17. A system for ascertaining topical items of interaction by user devices communicatively connected to a communications network, the user devices, respectively, having respective network identifiers on the communications network, the topical items correspond to at least one particular article accessible by the user devices, respectively, from a server communicatively connected to the communications network, comprising:
a receiver for obtaining the respective network identifiers of the user devices, respectively;
an iterator communicatively connected to the receiver, the iterator determines a subset of the user devices, respectively, interacting with the at least one particular article via communications of the user devices with the server over the communications network;
an analyzer communicatively connected to the iterator, the analyzer derives at least one topical item of the at least one particular article, for each user device of the subset and for all of the user devices of the subset; and
a reporter communicatively connected to the analyzer for delivering the at least one topical item and the respective network identifiers of the user devices of the subset corresponding to the at least one topical item, for each user device of the subset and for all of the user devices of the subset.

18. The system of claim 17, further comprising:
a segmenter communicatively connected to the reporter, the segmenter analyzes the at least one topical item and the user devices of the subset for targeted advertising.

19. The system of claim 18, further comprising:
a digital advertiser communicatively connected to the segmenter for communicating with the subset of the user devices corresponding to the at least one topical item.

20. The system of claim 17, further comprising:
a proxy device communicatively connected to the reporter and the communications network, the proxy device searches the communications network in respect of the at least one topical item for another at least one particular article.

21. The system of claim 20, further comprising:
a digital advertiser communicatively connected to the proxy device for communicating with the subset of the user devices in respect of at least one topical item of the other at least one particular article.

22. A method, comprising:
receiving by a processing device communicatively connected to a communications network, respective network identifiers of a group of user devices, respectively, communicatively connected to the communications network;
iterating by the processing device a subset of the user devices, respectively, interacting with at least one particular article, by detecting from a social network server communicatively connected to the communications network the subset of the user devices interacting with the at least one particular article via communications of the user devices with the social network server over the communications network;
analyzing by the processing device the at least one particular article and the subset of the user devices to obtain at least one topical item of the at least one particular article, for each user device of the subset and for all of the user devices of the subset; and
reporting by the processing device the at least one topical item and the respective network identifiers of the user devices of the subset corresponding to the at least one topical item, for each user device of the subset and for all of the user devices of the subset.

23. The method of claim 22, further comprising:
segmenting by the processing device the at least one topical item and the user devices of the subset for targeted advertising.

24. The method of claim 23, further comprising:
providing a digital ad via the communications network by the processing device to the user devices, respectively, from segmenting, at the respective network identifiers for the user devices, respectively, from segmenting.

25. The method of claim 22, further comprising:
determining other user devices via communications of the processing device over the computer network system to the other user devices, for the at least one topical item as proxy.

26. The method of claim 25, further comprising:
providing a digital ad via the computer network system by the processing device to the other user devices.
